(19) United States
(12) Patent Application Publication
(10) Pub. No.: US 2026/0155868 A1
(43) Pub. Date: Jun. 4, 2026

(54) Adaptive Antenna Configurations for Mobile Communication Device Accessories

(71) Applicant: Zebra Technologies Corporation, Lincolnshire, IL (US)

(72) Inventors: Giovanni P. Ritieni, Stony Brook, NY (US); Sheng Du, East Setauket, NY (US)

(73) Assignee: Zebra Technologies Corporation, Lincolnshire, IL (US)

(21) Appl. No.: 18/968,697

(22) Filed: Dec. 4, 2024

(51) Int. Cl. H04B 7/06; H01Q 1/22

(52) U.S. Cl. CPC H04B 7/0602; H01Q 1/22

(57) ABSTRACT

An accessory for a computing device includes: a cradle configured to support the computing device; a first antenna having a first radiation pattern; a second antenna having a second radiation pattern; a connector configured to receive signals from the computing device when the computing device is supported by the cradle; and a switch configured to selectively connect at least one of the first antenna or the second antenna with the computing device via the interface.

### BACKGROUND

Mobile computing devices can include antennas for communicating with other devices according to a variety of communication standards. Under some conditions, e.g., dependent on the operations a mobile computing device is deployed to support, constraints on space available for the antennas within the device may impede communication performance.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a computing device and mounting accessory.

FIG. 2 is a diagram illustrating the computing device of FIG. 1 from the rear.

FIG. 3 is a diagram illustrating certain internal components of the computing device of FIG. 1.

FIG. 4 is a diagram illustrating antennas and radiation patterns of the accessory of FIG. 1.

FIG. 5 is a flowchart of a method of controlling accessory antennas.

FIG. 6 is a diagram illustrating a first example performance of the method of FIG. 5.

FIG. 7 is a diagram illustrating a second example performance of the method of FIG. 5.

FIG. 8 is a diagram illustrating a further example of an accessory.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Examples disclosed herein are directed to an accessory for a computing device, the accessory including: a cradle configured to support the computing device; a first antenna having a first radiation pattern; a second antenna having a second radiation pattern; a connector configured to receive signals from the computing device when the computing device is supported by the cradle; and a switch configured to selectively connect at least one of the first antenna or the second antenna with the computing device via the interface.

Further examples disclosed herein are directed to a method in a computing device, the method comprising: detecting that an interface of the computing device is connected to an accessory having a first antenna and a second antenna and a switch configured to selectively activate at least one of the first antenna and the second antenna; determining an operating mode of the computing device; selecting an antenna configuration based on the operating mode; and transmitting a command to a switch of the accessory based on the selected antenna configuration.

Additional examples disclosed herein are directed to a computing device, comprising: a wireless communications interface; an accessory interface; and a processor configured to: detect that the accessory interface is connected to an accessory having a first antenna and a second antenna and a switch configured to selectively activate at least one of the first antenna and the second antenna; determine an operating mode of the computing device; select an antenna configuration based on the operating mode; and transmit a command to a switch of the accessory based on the selected antenna configuration.

Still further examples disclosed herein are directed to a method in an accessory for a computing device, the method comprising: receiving a command, from the computing device via an electrical interface of the accessory is connected to the computing device; and at a switch of the accessory, selectively connecting, based on the command, at least one of a first antenna of the accessory or a second antenna of the accessory with the computing device via the electrical interface.

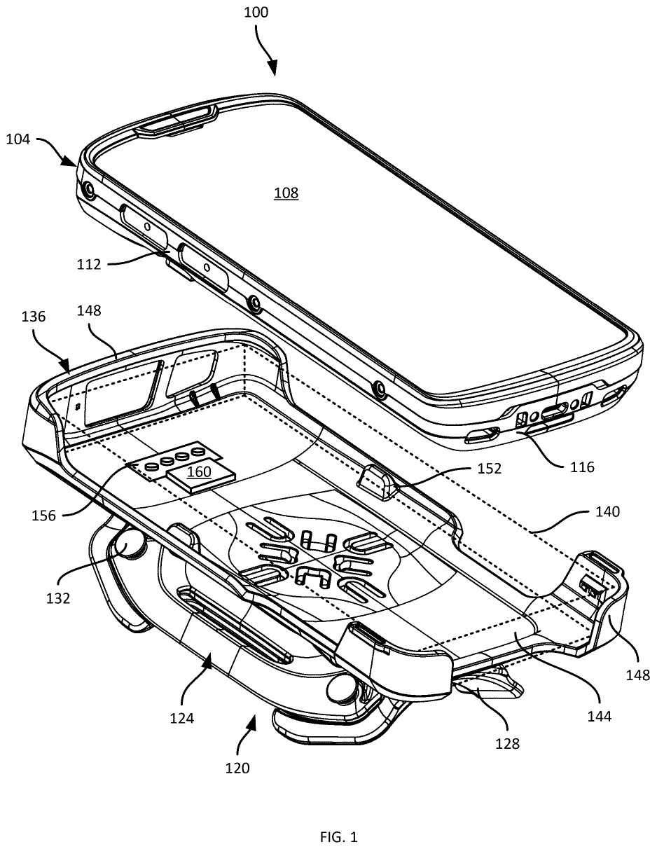

FIG. 1 illustrates a computing device 100 (also referred to herein as the device 100), such as a handheld computer or a smartphone. The device 100 can, in other examples, include any of a wide variety of other computing devices, such as a barcode scanner, a tablet computer, or the like. The computing device 100 includes a housing 104 supporting various other components of the device 100, including a display 108, e.g., integrated with a touch screen. The housing 104 can include, for example, a side wall 112 and an opposing side wall (not visible in FIG. 1), as well as a bottom wall 116 and an opposing top wall (not visible in FIG. 1), together forming a boundary around the display 108. The housing 104 can further include a rear wall opposite the display 108.

The device 100, in this example, can be operated in a handheld manner. Certain operating conditions may favor hands-free operation of the device 100, and the device 100 can therefore also be coupled (e.g., removably) with an accessory 120, such as an arm mount in the illustrated embodiment. The accessory 120 includes a mount 124 configured to engage with an object, such as a forearm of an operator. The mount 124 can include, for example, a curved surface 128 configured to engage with the operator's arm or other suitable surface. The mount 124 can also include one or more fasteners 132 such as posts, clips, or the like, configured to receive a textile band or other mounting structure configured to encircle the arm of the operator and thereby couple the mount 124 to the arm, retaining the surface 128 against the arm. Depending on the nature of the accessory 120, the device 100 can be mounted to a wide variety of objects in addition to a human operator, and can also be mounted to a human operator in a wide variety of ways (e.g., to a leg, a belt, a lanyard, or the like).

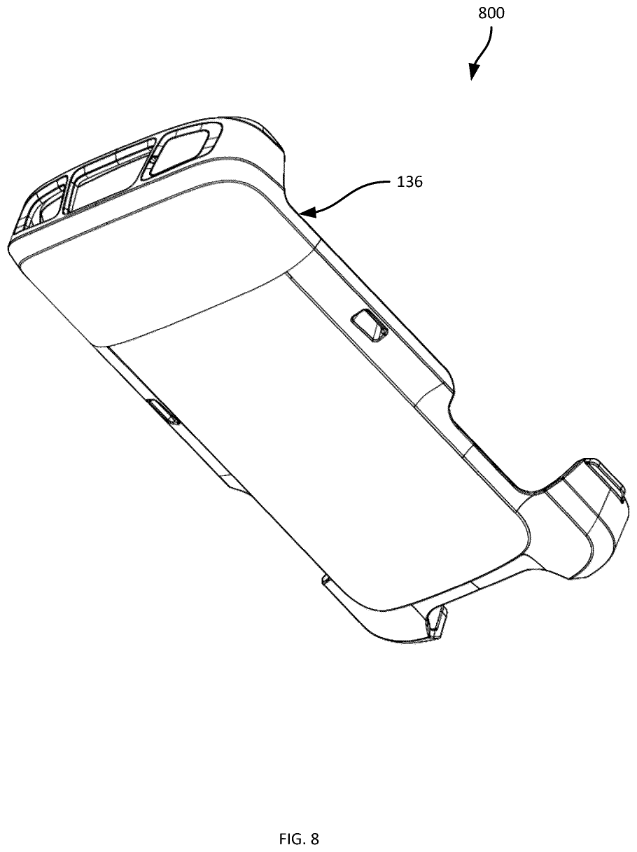

The structure of the mount 124 can therefore also vary depending on the object to which the device 100 is to be mounted. Other examples of mount include a component of a vehicle dock, e.g., to support the device 100 for visibility and/or use by the operator of a vehicle. In further examples, the mount 124 can be coupled to, or integrated with, a shopping cart or other transport device, e.g., to support the device 100 in a position to scan items being placed into the shopping cart. Other example accessories can omit the mount 124, e.g., an accessory 120 implemented as a boot for the device 100, e.g., a ruggedized boot to protect the device 100 against shocks or other environmental factors. An example accessory 800 is shown in FIG. 8 omitting the mount 124.

The accessory 120 also includes a cradle 136 supported on the mount 124, and configured to receive the computing device 100. The cradle 136 defines a volume 140 in which the device 100 is received when the device 100 is installed onto the cradle 136. The volume can be defined, for example, by an interior surface 144 and one or more side walls 148 extending outwards from the interior surface 144 (e.g., substantially perpendicularly from the interior surface 144). When the device 100 is placed into the volume 140, the rear wall opposite the display 108 can rest against the interior surface 144, and the walls 112 and 116 of the device 100 (as well as the opposing walls noted above) are bounded by the walls 148 of the cradle 136. The walls 148 and/or retaining features such as protrusions 152 can be configured to retain the device 100 against the interior surface 144. The interior surface 144 has a shape and size corresponding to the shape and size of the device 100, in this example. In other examples, the interior surface can include cutouts or the like, and need not extend over the entirety of the device 100. For example, the interior surface 144 can extend out to the walls 112, 116 (and opposite side and top walls) of the device 100 in some areas, but not others.

The device 100 includes at least one wireless communications interface supported within the housing 104. The wireless communications interface can include one or more antennas, as well as suitable control hardware and firmware for transmitting and receiving data via the antennas. The device 100 can include a plurality of antennas, e.g., permitting the device to communicate with other devices (e.g., other computing devices, radiofrequency (RF) tags, and the like) via a plurality of communication standards. For example, the device 100 may include a set of antennas enabling communications over wireless wide-area networks (WWANs) according to the 5G standard, for example. The device 100 can also, in addition to or instead of the WWAN antennas(s), include one or more antennas enabling communications over wireless local area networks (WLANs), e.g., WiFi networks. The device 100 can include further antennas for use in reading and/or writing data to or from RF identification (RFID) tags, exchanging data via near-field communication (NFC), or the like.

As discussed below, different modes of operation of the device 100 may involve different constraints or desired attributes on the performance of the above-mentioned antennas. For example, communications performance of the device 100 may be improved under some conditions by redirecting the main lobes of the radiation patterns emitted by at least some of the antennas. The antennas may not all be steerable, however, or may not be sufficiently steerable. Enabling the device 100 to radiate in different directions under different operating conditions may be achieved by providing the device 100 with additional antennas, e.g., one antenna for emitting RFID tag interrogation signals generally from the back of the device 100, and another antenna for emitting tag interrogation signals generally from the top wall of the device 100. The device 100 may have insufficient physical space to accommodate such additional antennas, however. Some accessories may have external antennas, e.g., to improve gain or other performance attributes of on-device antennas when the device 100 is in the cradle 136. However, such external antennas may also fail to accommodate multiple selectable modes of operation, which may in turn necessitate the use of distinct accessories for different operational use cases of the device 100.

The accessory 120, as discussed below, includes a plurality of antennas that can be selectively enabled or disabled. Enabling an antenna of the accessory 120 connects the antenna to an electrical interface 156 of the accessory 120, e.g., a set of electrical contacts, pogo pins, or the like, disposed on the inner surface 144. Disabling the antenna disconnects the antenna from the interface 156. The interface 156, in other words, establishes a direct electrical conduit with the device 100. In some examples, the interface 156 can include a wireless component in addition to, or instead of, the physically interconnecting components such as the contacts, pogo pins or the like mentioned above. For example, the interface 156 can include an inductive coil or other near-field element configured for coupling with a corresponding coil disposed in the device 100. The coils can be used to exchange control data between the device 100 and the switch 160, while physical connectors can be used to convey power and incoming and outgoing antenna signals. The accessory 120 can include a switch 160, e.g., implemented via an integrated circuit and connected between the interface 156 and the antennas. The switch 160 can be configured to close or open electrical connections between the interface 156 and the antennas, to control which antenna(s) are currently active (e.g., receiving signals from the device 100 via the interface 156 and thus acting as external antennas for the device 100).

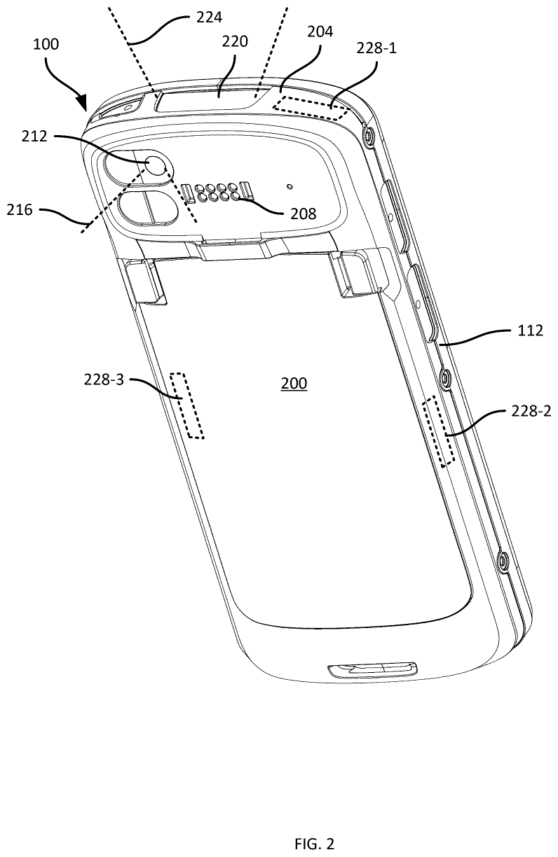

Referring to FIG. 2, the device 100 is shown from the back, including a rear wall 200, and an upper or top wall 204. The device 100 includes an interface 208 complementary with the interface 156, e.g., including one or more electrical contacts configured to convey power and data to the accessory 120. The device 100 can also include sensor modules, such as a camera 212 with a field of view extending from the back 200 of the device 100, and a scan module (which can include an additional image sensor) 220 with a field of view 224 extending from the top 204 of the device 100. As will be apparent, the use of the camera 212 to capture data, e.g., to scan barcodes, may involve placing the device 100 in a different orientation relative to the capture target than use of the scan module 220. The device 100 can also include one or more wireless communication interfaces, e.g., including an RFID reader or the like. The wireless communication interfaces can include antennas 228-1, 228-2, and 228-3 (the device 100 can include additional antennas in other examples), e.g., contained within the housing 104 at positions near the top wall 204, the side wall 112, and the back 200. For example, the antenna 228-1 may be associated with an RFID module of the device 100. The antenna 228-1 may not be steerable, however, and may have a radiation pattern with a main lobe intended to permit RFID reads both extending from the upper wall 204, and from the back 200, e.g., to support RFID reading alongside image capture using either of the camera 212 and the scan module 220. As a result, however, the antenna 228-1 may have suboptimal performance in each individual direction. The antennas of the accessory 120, and the selective enabling of those antennas, may improve the communications performance of the device 100, relative to the performance achieved with the antennas 228 alone.

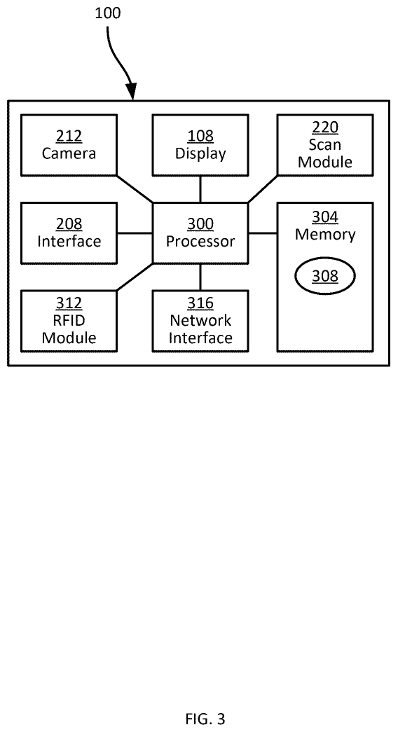

Turning to FIG. 3, certain internal components of the device 100 are shown. The device 100 includes a processor 300, such as a central processing unit (CPU), graphics processing unit (GPU), application-specific integrated circuit (ASIC), or the like. The processor 300 is communicatively coupled with a non-transitory computer-readable storage medium such as a memory 304, e.g., a combination of volatile memory elements (e.g., random access memory (RAM)) and non-volatile memory elements (e.g., flash memory or the like). The memory 304 stores a plurality of computer-readable instructions in the form of applications, including in the illustrated example an antenna configuration control application 308. Execution of the application 308 by the processor 300 configures the device 100 generate and send commands to the switch 160 of the accessory 120 to enable and disable the antennas of the accessory 120. In some examples, functionality associated with the application 308 can be incorporated into other applications at the device 100, e.g., one or more data capture applications configured to operate the camera 212, scan module 220, and/or RFID module.

The device 100 also includes one or more communications interfaces, including for example an RFID module 312, which controls the antenna 228-1 to emit interrogation signals and detect return signals from nearby RFID tags or the like. The device 100 can also include a network interface 316, e.g., implementing one or more WWAN standards (e.g., 5G or the like), one or more WLAN standards (e.g., for 802.11 networks) and controlling the antennas 228-2 and 228-3. As will be apparent, the device 100 can also include other communication interfaces. The device 100 can further include one or more input devices, such as a microphone, a touch screen (e.g., integrated with the display 142), a keypad, a scan trigger, or the like.

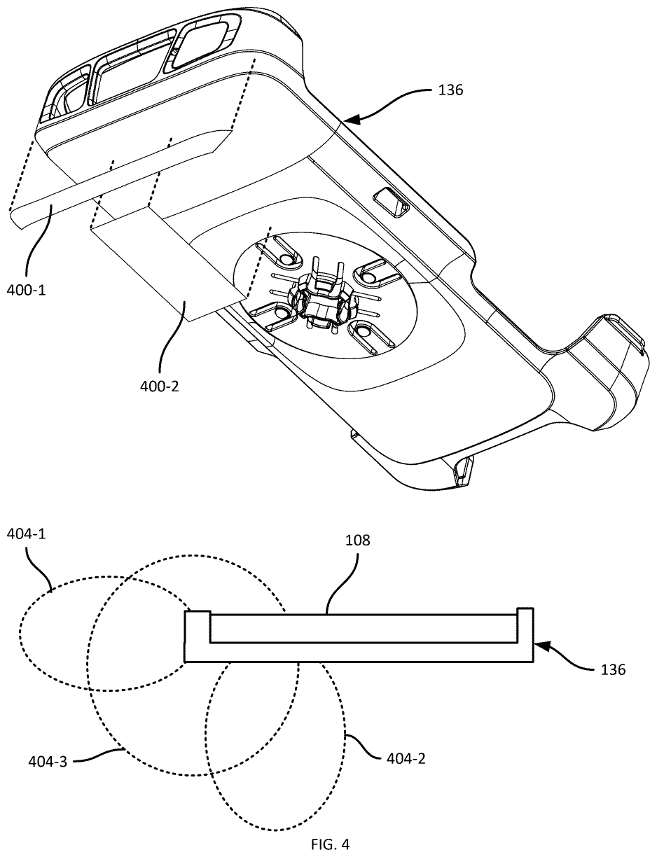

Turning to FIG. 4, the cradle 136 is shown separated from the mount 124. The cradle 136 includes, in this example, a first antenna 400-1 and a second antenna 400-2, e.g., embedded in or otherwise affixed to the cradle 136. The antennas 400 are electrically connected to the interface 156, e.g., via feed lines within the cradle 136. The shape, size, and position of each antenna 400 can be selected to provide a particular radiation pattern. For example, the antenna 400-1 can be configured to have a radiation pattern with a main lobe 404-1, extending upwards from the device 100 when enabled. The antenna 400-2 can be configured to have a radiation pattern with a main lobe 404-2 extending from the back of the device 100 when enabled. As will be apparent, the antenna 400-1 may therefore be suited for use by the RFID module 312 when the scan module 220 is active, while the antenna 400-2 may be suited for use by the RFID module 312 when the camera 212 is active. The antennas 400 can also be used for communications via other standards, including the WWAN and WLAN standards noted above, in some examples.

The antennas 400 can also be enabled simultaneously, such that signals from the RFID module 312 are applied at both the antenna 400-1 and the antenna 400-2 via the interface 156, e.g., to generate a further radiation pattern with a main lobe 404-3. The main lobe 404-3 may be substantially omnidirectional, for example. The cradle 136, and/or other portions of the accessory 120, can also include additional antennas 400 in other examples, e.g., to provide further radiation patterns for use by the RFID module 312, and/or to provide one or more additional radiation patterns for the network interface 316.

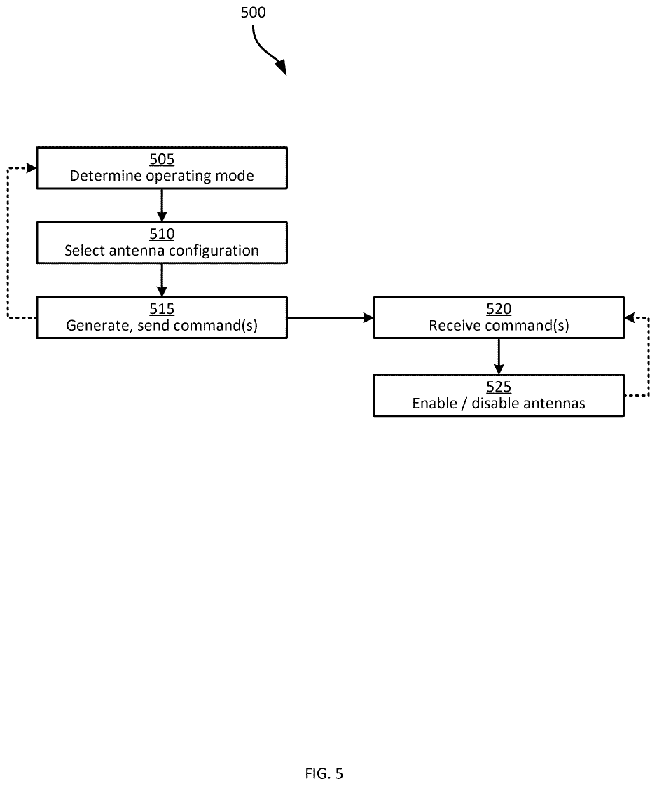

The accessory 120, via the interface 156, the switch 160, and the antennas 400, permits the device 100 to cause selective enabling or disabling of the antennas 400 to improve wireless communications performance of the device 100. Turning to FIG. 5, a method 500 of adaptive antenna configurations for mobile communication device mounts is shown. Certain blocks of the method 500 are performed by the device 100, while other blocks are performed by the accessory 120, e.g., by the switch 160, as set out below. At block 505, the device 100 is configured to determine an operating mode. As will be apparent, the method 500 can be initiated in response to detecting, at the device 100, that the interface 208 is connected to the accessory (e.g., to the interface 156).

The device 100 can maintain, e.g., in configuration data stored in the memory 304, as a component of the application 308, or the like, a set of operating mode definitions. Each definition can include one or more criteria that if met, indicate that the device 100 is in the corresponding operating mode. An example operating mode definition can include an identifier of a first data capture application, e.g., configured for use when the device 100 is used with a pistol grip (e.g., carrying the cradle 136) for scanning with the scan module 220. That is, if the first data capture application is active, the device 100 can determine at block 505 that the device 100 is in a first operating mode.

Various other operating mode definitions will also occur to those skilled in the art. For example, a further operating mode definition can include an identifier of a second data capture operation. A further operating mode definition can include, in addition to or instead of an application identifier, a motion data criterion such as an orientation of the device and/or an indication of whether the device 100 is in motion (e.g., has a non-zero velocity). For example, such a definition can identify a data capture application used when the device 100 is deployed in conjunction with a shopping cart, e.g., to scan items in the cart. The operating mode definition can also specify that the device 100 is in motion. Another operating mode definition can identify the same cart-based data capture application, and specify that the device 100 is stationary. Thus, while executing the cart-based data capture application, the device 100 may switch between operating modes depending on whether the cart (and therefore the device 100) is in motion.

At block 510, the device 100 is configured to select an antenna configuration based on the operating mode from block 505. The antenna configuration defines which of the antennas 400 on the accessory 120 is to be enabled, e.g., electrically connected with the RFID module 312 (or other communications interface of the device 100) via the interface 208, the interface 156, and the switch 160. The operating mode definitions mentioned above can include a mapping to antenna configurations, for example state indicators for each antenna 400. That is, the antenna configuration selected at block 510 can include a binary indicator for each antenna 400, indicating whether that antenna 400 is to be enabled or disabled. In other examples, binary state indicators for the antennas 400 can be stored at the switch 160 instead of at the device 100, and selecting an antenna configuration at block 510 can include retrieving an identifier of the operating mode determined at block 505.

At block 515, the device 100 is configured to generate and send one or more commands to the accessory 120, via the interface 208. The command(s) include the antenna configuration selected at block 510, e.g., in the form of a state indicator for each antenna 400, or in the form of an identifier of the operating mode determined at block 505.

At block 520, the accessory 120, e.g., the switch 160, is configured to receive the command(s) from the device 100, and at block 525 the switch 160 is configured to selectively connect one or more of the antennas 400 with the device 100 via the interface 156. That is, the switch 160 can be configured to open or close electrical paths between the antennas 400 and the interface 156. The device 100 can return to block 505 and determine a different operating mode, e.g., in response to changes in applications executing at the device 100, or the like. As a result, the device 100 can send commands corresponding to updated antenna configurations via subsequent performances of block 515, and the switch 160 can update which antenna(s) 400 are active via subsequent performances of block 520 and 525.

The provision of antennas 400 that can be selectively enabled or disabled at the accessory 120 can enable the device 100 to flexibly control external antennas to satisfy varying operational needs, e.g., without an operator of the device 100 switching between distinct accessories 120, each with static external antenna configurations.

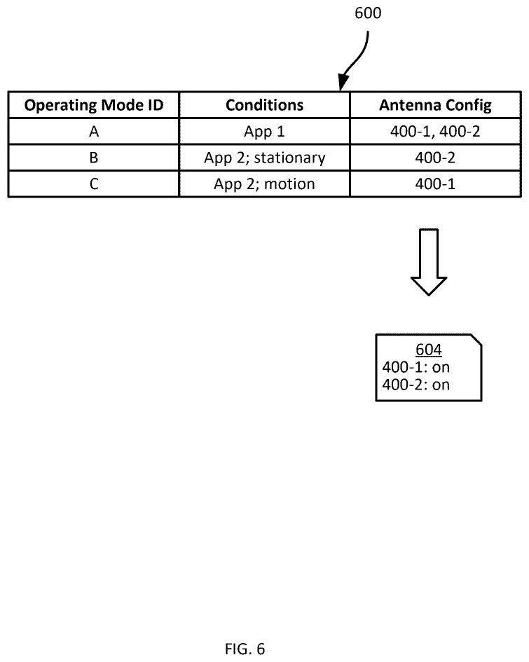

Referring to FIG. 6, a first example implementation of the operating mode definitions and antenna configurations mentioned above is shown. In this example, the device 100 can maintain operating mode definitions 600 each specifying an operating mode identifier, one or more conditions corresponding to the operating mode, and a corresponding antenna configuration. The device 100 can therefore, in response to determining that the operating mode “A” is currently active at block 505 (e.g., because the application “App 1” is being executed by the processor 300), select the antenna configuration corresponding to that operating mode. The relevant antenna configuration indicates that the antennas 400-1 and 400-2 are both to be enabled. The device 100 can send a command 604 to the switch 160 containing state indicators for the antennas 400-1 and 400-2.

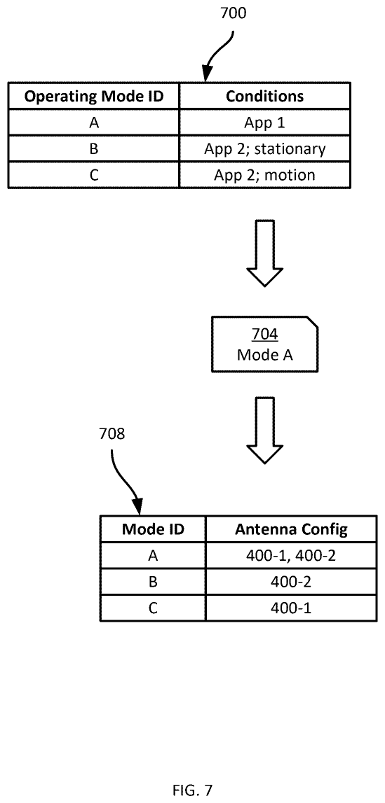

FIG. 7 shows a second example implementation of the operating mode definitions and antenna configurations mentioned above is shown. In this example, the device 100 can maintain operating mode definitions 700 each specifying an operating mode identifier, and one or more conditions corresponding to the operating mode. The antenna configurations need not be stored at the device 100, however. Instead, the device 100 can be configured to send a command 704 containing an identifier of the determined mode of operation to the switch 160. The switch 160 can store antenna configurations 708 corresponding to operating mode identifiers, and can select the antenna configuration corresponding to the mode identified in the command 704.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An accessory for a computing device, the accessory comprising:
a cradle configured to support the computing device;
a first antenna having a first radiation pattern;
a second antenna having a second radiation pattern;
an electrical interface configured to receive signals from the computing device when the computing device is supported by the cradle; and
a switch configured to selectively connect at least one of the first antenna or the second antenna with the computing device via the electrical interface.

2. The accessory of claim 1, wherein the switch is configured to:
receive a mode identifier from the computing device via the electrical interface;
determine an antenna configuration corresponding to the mode identifier; and
selectively connect at least one of the first antenna or the second antenna according to the determined antenna configuration.

3. The accessory of claim 2, wherein the switch is configured to:
store a mapping of mode identifiers to antenna configurations; and
determine the antenna configuration based on the mapping and the received mode identifier.

4. The accessory of claim 1, wherein the switch is configured to:
receive, from the computing device via the electrical interface, (i) a first control state corresponding to the first antenna, and (ii) a second control state corresponding to the second antenna; and
selectively connect at least one of the first antenna or the second antenna according to the received first and second control states.

5. The accessory of claim 1, wherein the first radiation pattern includes a main lobe extending from a upper portion of the cradle;
wherein the upper portion corresponds to a field of view of a scan assembly of the computing device.

6. The accessory of claim 1, wherein the second radiation pattern includes a main lobe extending from a back portion of the cradle;
wherein the back portion corresponds to a field of view of a rear camera of the computing device.

7. The accessory of claim 1, wherein the first antenna and the second antenna have a combined radiation pattern distinct from the first radiation pattern and the second radiation pattern.

8. The accessory of claim 7, wherein the switch is configured to:
in response to a first type of command received via the electrical interface, connect the first antenna to the electrical interface and disconnect the second antenna from the electrical interface;
in response to a second type of command received via the electrical interface, connect the second antenna to the electrical interface and disconnect the first antenna from the electrical interface; and
in response to a third type of command received via the electrical interface, connect the first antenna and the second antenna to the electrical interface.

9. A method in a computing device, the method comprising:
detecting that an electrical interface of the computing device is connected to an accessory having a first antenna and a second antenna and a switch configured to selectively activate at least one of the first antenna and the second antenna;
determining an operating mode of the computing device;
selecting an antenna configuration based on the operating mode; and
transmitting a command to a switch of the accessory based on the selected antenna configuration.

10. The method of claim 9, further comprising:
transmitting signals to the switch via the electrical interface, for transmission via at least one of the first and second antennas according to the antenna configuration.

11. The method of claim 9, wherein determining the operating mode includes:
determining that a predetermined application is active at the computing device 12. The method of claim 9, wherein determining the operating mode includes:
determining that an orientation of the computing device satisfies a first condition, or determining that a velocity of the computing device satisfies a second condition.

13. The method of claim 9, wherein transmitting the command includes:
retrieving from a memory, based on the selected antenna configuration, a first state corresponding to the first antenna, and a second state corresponding to the second antenna; and
transmitting the first state and the second state to the switch.

14. The method of claim 13, wherein transmitting the command includes transmitting an identifier of the antenna configuration.

15. A computing device, comprising:
a wireless communications interface;
an accessory interface; and
a processor configured to:
detect that the accessory interface is connected to an accessory having a first antenna and a second antenna and a switch configured to selectively activate at least one of the first antenna and the second antenna;
determine an operating mode of the computing device;
select an antenna configuration based on the operating mode; and
transmit a command to a switch of the accessory based on the selected antenna configuration.

16. The computing device of claim 15, wherein the processor is configured to:
transmit signals to the switch via the accessory interface, for transmission via at least one of the first and second antennas according to the antenna configuration.

17. The computing device of claim 15, wherein the processor is configured to determine the operating mode by:
determining that a predetermined application is active at the computing device

18. The computing device of claim 15, wherein the processor is configured to determine the operating mode by:
determining that an orientation of the computing device satisfies a first condition, or determining that a velocity of the computing device satisfies a second condition.

19. The computing device of claim 15, wherein the processor is configured to transmit the command by:
retrieving from a memory, based on the selected antenna configuration, a first state corresponding to the first antenna, and a second state corresponding to the second antenna;
and transmitting the first state and the second state to the switch.

20. The computing device of claim 15, wherein the processor is configured to transmit the command by transmitting an identifier of the antenna configuration.

21. A method in an accessory for a computing device, the method comprising:
receiving a command, from the computing device via an electrical interface of the accessory is connected to the computing device; and
at a switch of the accessory, selectively connecting, based on the command, at least one of a first antenna of the accessory or a second antenna of the accessory with the computing device via the electrical interface.

22. The method of claim 21, wherein the command includes an operating mode identifier; the method further comprising:
at the switch, retrieving an antenna configuration based on the operating mode identifier; and
selectively connecting at least one of the first antenna or the second antenna according to the antenna configuration.

23. The method of claim 21, wherein the command includes a state indicator for each of the first antenna and the second antenna; the method further comprising:
selectively connecting at least one of the first antenna or the second antenna according to the state indicators.
